(19) United States
(12) Patent Application Publication
(10) Pub. No.: US 2014/0025430 A1
(43) Pub. Date: Jan. 23, 2014

(54) System And Method For Graphically Displaying Marketing Data

(71) Applicant: Massively Parallel Technologies, Inc., Boulder, CO (US)

(72) Inventor: Kevin D. Howard, Tempe, AZ (US)

(73) Assignee: Massively Parallel Technologies, Inc., Boulder, CO (US)

(21) Appl. No.: 13/909,836

(22) Filed: Jun. 4, 2013

Related U.S. Application Data
(60) Provisional application No. 61/655,157, filed on Jun. 4, 2012.

(51) Int. Cl. G06Q 30/02

(52) U.S. Cl. CPC G06Q 30/0204
USPC 705/7.33

(57) ABSTRACT

A system and method for graphically depicting an entire cloud economy by use of a graphical display allows at-a-glance understanding of the effects of pricing and effects of upgrades. The graphical display also shows the economic footprint of certain (Kernel) algorithms, and shows the rate of relative economic change between those algorithms.

### RELATED APPLICATIONS

This application claims priority to U.S. Patent Application Ser. No. 61/655,157, titled “System and Method for Graphically Displaying Marketing Data”, filed Jun. 4, 2012, and incorporated herein by reference. U.S. Patent Application Publication Number 2012/0036399 A1, titled “System and Method for Automated Software Application Development”, filed Aug. 9, 2010, and U.S. Patent Application Ser. No. 61/531,973 titled “Parallel Processing Development Environment Extensions”, filed Sep. 7, 2011, are incorporated herein by reference. These co-owned applications are included for enablement purposes and provide details of the software development environment referenced herein.

### BACKGROUND

For a software developer, knowing what to develop is typically a dilemma. Equally problematic for the developer is determining how ones software products compare to other, similar, offerings. Standard methods of comparing products include product feature comparison tables, performance comparisons charts, and market penetration/size studies among others. Without large economic resources and specialized experience/training these methods are out-of-bounds for most small organizations and individual developers.

### SUMMARY OF THE INVENTION

In Cloud Computing models containing multiple organizations and developers, the Cloud environment may generate marketing information. Automatic generation solves part of the problem but does not address the needs of the non-specialist to quickly grasp their position in the marketplace with enough fidelity for the specialist. This application discloses embodiments to graphically depict an entire cloud economy. Use of this graphical display allows at-a-glance understanding of Kernel-Algorithm launches, the effects of pricing, the effects of upgrades, It also shows the economic footprint of all Kernel-Algorithms, and shows the rate of relative economic change between Kernel-Algorithms.

At least one embodiment is disclosed which includes a method for graphically displaying marketing data for a plurality of marketed products, where each product is developed by one of a plurality of organizations using a development environment, the method including generating, via a processor and within memory coupled to the development environment, a landscape formed of at least two areas, wherein each area has a size representative of a total financial value of at least one product of an organization and/or a category of products. The method further may include generating, via the processor and within each of said areas, at least one symbol representative of the at least one product. The method further yet may include displaying said landscape and said symbols from said development environment.

Another embodiment is disclosed which includes a system for graphically displaying marketing data for a plurality of marketed products, where each product is developed by one of a plurality of organizations using a development environment, the system including memory, the memory storing a market analyzer executable by a processor for generating a landscape formed of at least two areas, each area having a size representative of a total financial value of at least one product of an organization and/or a category of products; generating, within each of the at least two areas, at least one symbol representative of the at least one product; and, displaying the landscape and at least one symbol from the development environment.

### BRIEF DESCRIPTION OF THE FIGURES

FIG. 1 shows one exemplary cloud based parallel processing development environment within a computing cloud, in an embodiment.

FIG. 2 shows one exemplary Category/Kernel-Algorithm display that may represent the graphical marketing display of FIG. 1, in an embodiment.

FIG. 3 shows one exemplary Organization/Kernel-Algorithm display that may represent the graphical marketing display of FIG. 1, in an embodiment.

FIGS. 4A, 4B and 4C show exemplary overlay of organizations, in an embodiment.

FIGS. 5A, 5B, and 5C show exemplary overlay of Kernel-Algorithms, in an embodiment.

FIGS. 6A, 6B, and 6C show exemplary overlay of Kernel-Algorithm launches, in an embodiment.

FIG. 7 shows one exemplary Category/Kernel-Algorithm Tracking view illustrating the top three winning bids, indicated over the Kernel-Algorithm designation.

FIG. 8 is a flowchart illustrating one exemplary method for graphically displaying marketing data for a plurality of marketed products, where each product is developed by one of a plurality of organizations using a development environment, in one embodiment.

### DETAILED DESCRIPTION OF THE FIGURES

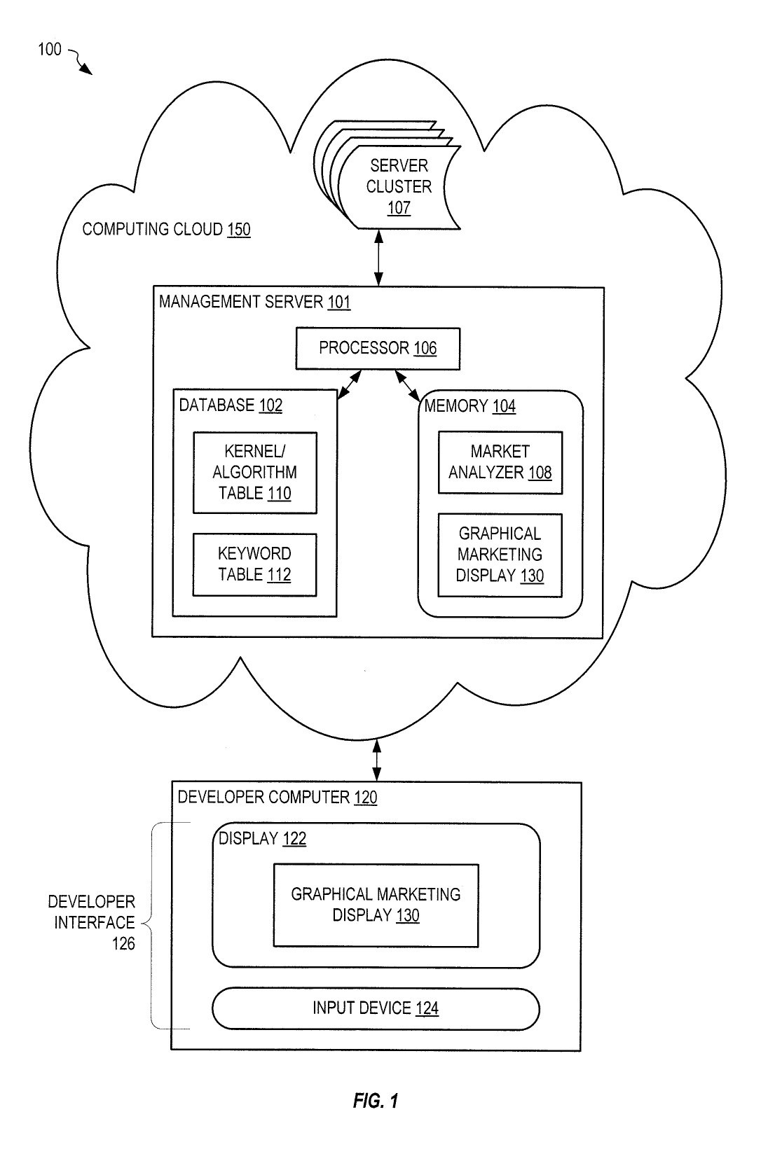

FIG. 1 shows one exemplary cloud based parallel processing development environment 100 within a computing cloud 150. Development environment 100 includes a management server 101 and a server cluster 107. Management server 101 includes a database 102, a memory 104, and a processor 106. Although shown as a single computer system, management server 101 may include multiple computer systems (e.g., computer servers) that are interconnected (e.g., using a computer network). Where implemented as multiple computer systems, these systems may be co-located and interconnected using a local area network, and/or distributed and interconnected using wide area networks (e.g., the Internet, dedicated networks, and so on). Database 102 is a data network storage device, for example.

Memory 104 may represent one or more of volatile memory (e.g., RAM, DRAM, static memory, and so on) and non-volatile memory (e.g., FLASH, magnetic media, optical media, and so on). Memory 104 is shown storing a market analyzer algorithm 108 that comprises machine readable instructions that when executed by processor 106 process data within database 102 to generate a graphical marketing display 130 on developer computer 120.

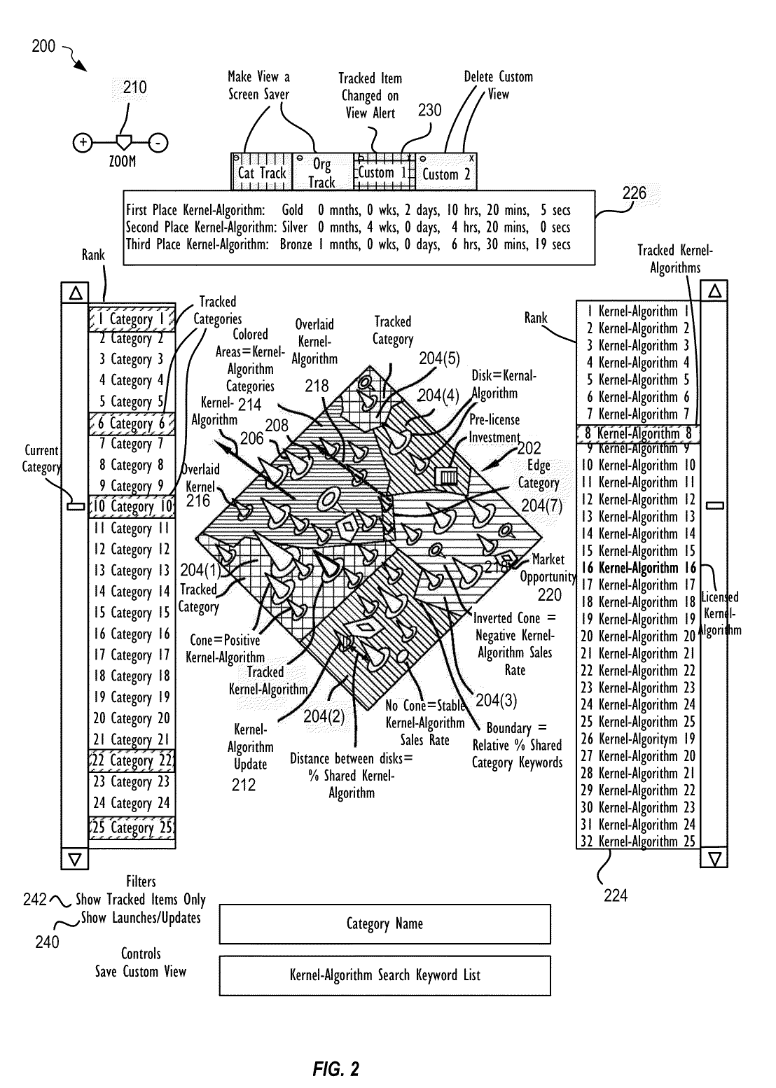

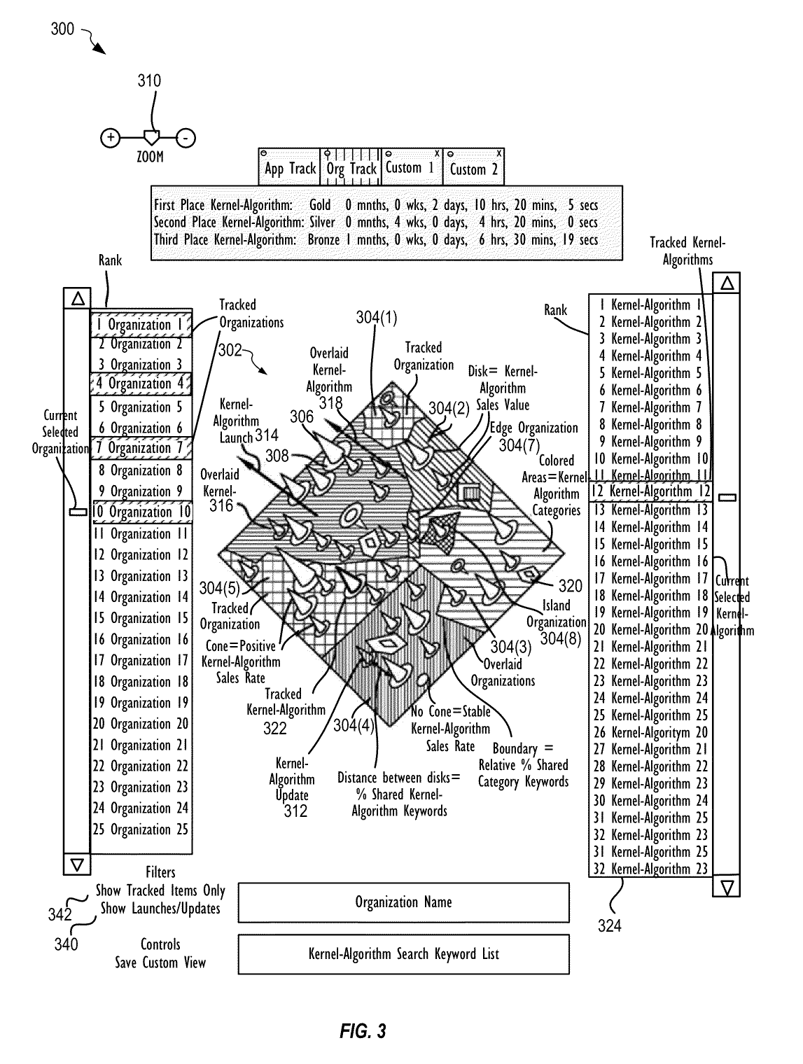

Market analyzer algorithm 108 utilizes principles of isometric projection to generate graphical marketing display 130 based upon a condensed information conveyance model. Graphical marketing display 130 has two views: Category/Kernel-Algorithm and Organization/Kernel-Algorithm, as shown in FIGS. 2 and 3 and described below.

FIG. 2 shows one exemplary Category/Kernel-Algorithm display 200 that may represent graphical marketing display 130 of FIG. 1. Display 200 may also be referred to herein as a “tracker” (e.g., Cat Track—short for category tracker, Org Track—short for organization tracker). Display 200 shows exemplary dense real-time economic information that is automatically generated from information within database 102 by market analyzer algorithm 108. Database 102 stores information generated by activity within system 100, including development of kernels and algorithms, use and sales of kernels and algorithms, and requirements for new kernels and algorithms.

In the Categaory/Kernel-Algorithm display 200, a landscape 202 (i.e., the isomorphic rectangle) is composed of categories 204(1)-(7). The area of each category 204 represents the total economic value of that category. Each total economic value is computed by algorithm 108, which sums the sales values, stored within kernel/algorithm table 110 of database 102, of all Kernel-Algorithms within that category. Each sales value is calculated by multiplying the sales rate of the kernel/algorithm by its license fee. Each category 204 represents an organization defined grouping of kernels/algorithms within system 100.

Each cone 206 and disk 208 symbol represents a Kernel-Algorithm. A positive Kernel-Algorithm sales rate (e.g., indicating an increase in sales as compared to a previous period) places the cone 206 above the disk 208 with the point of the cone pointing upward. A negative Kernel-Algorithm sales rate (e.g., indicating a reducing sales rate as compared to a previous period) is shown as an inverted cone 206 below the disk 208 with the point of the cone pointing downward. In each case, the height of the cone indicates the amount of change in sales as compared to the previous period. A stable Kernel-Algorithm sales rate is represented by no cone, just a disk 208. The Kernel-Algorithm economic value is represented by the size of the associated disk 208.

The height of the cone is determined by first calculating an average sales rage using the following equation:

$$A = \frac{( {\sum }_{n = 1}^{x} {P}_{n} )}{x}$$

where:
A=Average sales rate
n=current sales rate instance
x=maximum number of sales rates
Pₙ=n^{th} sales rate

An then calculating the height of the cone using the equation:

$${H}_{n} = \frac{M * {P}_{n}}{A}$$

where:
Hₙ=height of the n^{th} cone
M=maximum height of a positive cone

M is predefined within the system. If a negative sales rate is determined, the displayed cone is reversed. There are two possible compute times: instantaneous and periodic. Instantaneous calculations are performed after every sale. Periodic calculations are performed over some input time interval. Either method can be used to determine the how often the calculations are performed.

The distance between disks 208 represents the number of keywords, derived by algorithm 108 from keyword table 112 of database 102, shared by the Kernel-Algorithms, wherein the fewer shared keywords between each pair of kernel algorithms within that category, the further apart the disks 208. The keywords for each kernel/algorithm are generated by the organization designing that Kernel-Algorithm within system 100, wherein the sum of the keywords of all features (i.e., the functionality of that Kernel-Algorithm) forms the keyword list for that Kernel-Algorithm. The length of a border shared by two categories 204 represents the percentage of shared keywords between those two categories.

A new code revision for an existing Kernel-Algorithm is an update to that Kernel-Algorithm, which results in the re-launching of that existing Kernel-Algorithm with either additional functionality or repaired errors. If a “Show Launches/Update” filter within algorithm 108 has been selected (e.g., using Show Launches/Update button 240), then each re-launched kernel-algorithm is represented by a cone-and-disk 212 that is red and flashing, and the launch of a new product is represented by a red, flashing, arrow 214, without an associated disk (since an economic value is not yet established).

If two or more Kernel-Algorithms have the same keyword list, they are considered overlaid Kernel-Algorithms. Overlaid Kernel-Algorithms are displayed as cones with dashed internals 216. Two or more Kernel-Algorithm launches with the same keyword list are considered overlaid Kernel-Algorithm launches and are depicted as a dashed arrow 218.

Consumer interest in certain combination of keywords that is not currently served by a Kernel-Algorithm is considered market opportunity, which is represented with landscape 202 as an area 220 that is lighter in color (e.g. shadowed/filled within the figures) than the surrounding landscape. Thus, display 200 shows market demand in real time.

A Kernel-Algorithm whose activity is being tracked is highlighted by a bold outline 222 on tracking display 200 and with letters on a kernel-algorithm selection bar 224. If the sales rate or sales value of the tracked Kernel-Algorithm has changed by more than its pre-set value, the bold cone outline 222 flashes and the tab 230 of every view containing that tracked Kernel-Algorithm changes its color to bright flashing yellow. A flashing yellow tab continues to flash until that view has been selected, then the flashing stops and the color returns to the standard tab color.

Categories whose activities are being tracked (e.g., category 204(5)) are colored bright yellow (as represented by the cross hatched fill within the figures). Any changes greater than the pre-set percentage in the tracked category causes the yellow color (cross hatched fill) of the category to flash and the associated tabs (e.g., tab 230) of all tracked views containing the tracked category change to bright, flashing yellow. An edge category (e.g., edge category 204(7)) occurs when a Kernel-Algorithm's keyword list lies fully at the border between two or more adjacent categories. The width of the edge category depicts the total economic value of all Kernel-Algorithms within it.

It is possible to zoom into and out of landscape 202 using a zoom control slider 210. If only the selected categories and Kernel-Algorithms are desired for display, then the Show Tracked Items Only button 242 is selected.

An indication of the Kernel-Algorithms generating maximum economic value is calculated by ranking all displayed Kernel-Algorithms and then displaying a table 226 of the first, second, and third place Kernel-Algorithms at the top of display 200. Any of the tracking views may be saved as an active screen saver, showing all of the requested economic activity in real time.

FIG. 3 shows one exemplary Organization/Kernel-Algorithm display 300 that may represent graphical marketing display 130 of FIG. 1, and that is generated by marketing analyzer algorithm 108 from information within database 102. Organization/Kernel-Algorithm display 300 illustrates a landscape 302 composed of organizations 304, where the area of each organization 304 represents the total economic value of that organization. This total economic value is computed by algorithm 108, which sums the sales value of all Kernel-Algorithms within that organization. As in the Category/Kernel-Algorithm display 200, the sales value is calculated by multiplying the sales rate by the license fee.

A cone 306 and a disk 308 symbol represents a Kernel-Algorithm. A positive Kernel-Algorithm sales rate (e.g., where the amount of sales for a current period is greater than sales for a previous period) is shown by cone 306 positioned above the disk 308 with the point of the cone pointing upward. A negative Kernel-Algorithm sales rate (e.g., where the amount of sales for a current period is less than sales for a previous period) is shown by an inverted cone 306 below the disk 308 with the point of the cone pointing downward. A stable Kernel-Algorithm sales rate is represented by no cone, just a disk 308. The Kernel-Algorithm economic value is represented by the size of the associated disk. The height of the cone indicates an amount of sales increase or decrease for the current period as compared to a previous period and is calculated as described above.

The distance between disks 308 represents the number of keywords shared by the Kernel-Algorithms, with the fewer the shared keywords, the further apart the disks. The keyword lists are generated from an organization designing a Kernel-Algorithm. The length of a border shared by two organizations represents the relative percentage of shared keywords between those two organizations. The sum of the keywords of all features forms the keyword list of a Kernel-Algorithm.

If two or more Kernel-Algorithms have the same keyword list, they are considered overlaid Kernel-Algorithms. Overlaid Kernel-Algorithms are displayed as cones with dashed internals 316. The launch of a new product is represented by a flashing arrow 314, without an associated disk (since an economic value is not yet established). Flashing arrow 314 may be of a different color, for example red. Two or more Kernel-Algorithm launches with the same keyword list are considered overlaid Kernel-Algorithm launches and are depicted as a dashed arrow 318.

Consumer interest in a certain combination of keywords that is not currently served by a Kernel-Algorithm is shown as an area (e.g., area 320) in the landscape 302 that is lighter in color (i.e. not filled within the figures) than the surrounding organization 304. Such an area is considered a market opportunity.

A new code revision for an existing Kernel-Algorithm is called a Kernel-Algorithm update and represents a re-launching of an existing Kernel-Algorithm with either additional functionality or repaired errors. If the Show Launches/Update button 340 has been selected, these re-launches are represented by the standard cone-and-disk but colored red (see kernel-algorithm update 312) and flashing and the launch of a new product is represented by a red flashing arrow 314, without an associated disk.

Island organizations (e.g., island organization 304(8) represented by small cross hatch fill) are fully surrounded by another organization (e.g., organization 304(3)). Island organizations represent an organization whose keyword list is completely within the keyword list of another organization but whose total economic value is less than the other organization's total economic value. Overlaid organizations share the same keyword list and have the same total economic value. Overlaid organizations are represented by a red color (e.g., organization 304(4) as represented by horizontal fill). Selecting overlaid organizations causes multiple popup displays, each with a component of the overlay displayed.

Organizations whose activities are being tracked are colored bright yellow (e.g., organizations 304(1) and 304(5) as represented by large cross hatch fill). Any changes greater than the pre-set percentage in the tracked organization causes the yellow color of the organization to flash and the associated tabs of all tracked views containing the tracked organization to change to bright, flashing yellow. A Kernel-Algorithm whose activity is being tracked is highlighted by a red outline 322 on the tracking display and with red letters on the selection bar 324. If the tracked Kernel-Algorithm changes its sales rate or sales value by more than its pre-set value, the red cone outline flashes and the tab of every view containing that tracked Kernel-Algorithm changes to bright flashing yellow. A flashing yellow tab continues to flash until that view has been selected, which causes the flashing to stop and the color to return to the standard tab color.

It is possible to zoom into and out of landscape 300 using a zoom control arrow 310. Tracking displays 200 and 300 may also allow instant messaging communication between end users and administrators of organizations and/or Kernel-Algorithms. If only the selected organizations and Kernel-Algorithms are desired for display, the Show Tracked Items Only button 342 is selected. An indication of the Kernel-Algorithms generating maximum economic value is calculated by ranking all displayed Kernel-Algorithms then displaying the first, second, and third place Kernel-Algorithms at the top of display 300. Any of the tracking views may be saved as an active screen saver, displaying all of the requested economic activity in real time.

### Custom Displays

Since various categories, organizations, and Kernel-Algorithms may be selected for tracking purposes, the end user may create multiple tracking combinations and save them separately as custom views. A custom display is created by first selecting the desired configuration (categories or organizations and Kernel-Algorithms, product launches/updates, etc.) then selecting the Save Custom View button. Upon selection of the Save Custom View button, the server 101 displays the Tab Naming popup screen. Entering a tab name followed the selection of the Done button causes server 101 to build and transmit the Tab Name message to a server cluster 107, also known as a massively parallel cluster.

Upon the receipt of the Tab Name message, the server cluster 107 attempts to add the new custom view to its user database. If the new custom view is successfully added to the user database, the server cluster 107 generates and transmit the Return Status message containing a zero in its status field. Upon receipt of the Return Status message containing a zero in its status field, the server 101 displays the New Custom View tab. If the server cluster 107 is unable to successfully add the new custom view to its user database, it generates and send the Return Status message containing a non-zero in its status field. Upon receipt of the Return Status message containing a non-zero in its status field, the server 101 displays the message New Custom View Unsuccessfully Added, and no additional tab is displayed.

Each tab contains the thirty-two character tab name and the base view type. The base view is generated from the originating tracker view. If the originating tracker view is Category/Kernel-Algorithm then any custom view derived from it will have a base view of Category. Similarly, if the originating tracker view is Organization/Kernel-Algorithm then any custom view derived from it will have a base view of Organization. A new custom view can be derived from another custom view as well. Whatever the base-view of the originating custom view, it is the same as the new custom view.

To delete a custom display, the end user selects the Delete Custom View button located on the top-right corner of each custom view tab. Upon selection of the Delete Custom View button, the server 101 generates and send the Tab Delete message to the server cluster 107.

Upon receipt of the Tab Delete message, the server cluster 107 attempts to delete the selected custom view from its user database. If the server cluster 107 is successful in deleting the selected custom view from its user database, it creates and send the Return Status message containing a zero in its status field to the server 101. Upon receipt of the Return Status message containing a zero in its status field, the server 101 removes the custom view and associated tab from the display. If the server cluster 107 is unsuccessful in deleting the selected custom view from its user database, it creates and send the Return Status message containing a non-zero in its status field to the server 101. Upon receipt of the Return Status message containing a non-zero in its status field, the server 101 displays the Custom View Unsuccessfully Deleted error message without removing the selected tab or custom view.

Selection of a tab in any location other than via a Make a Screen Saver or Delete Custom View button causes the view associated with that tab to become the topmost view on the display.

### Expanding Overlays

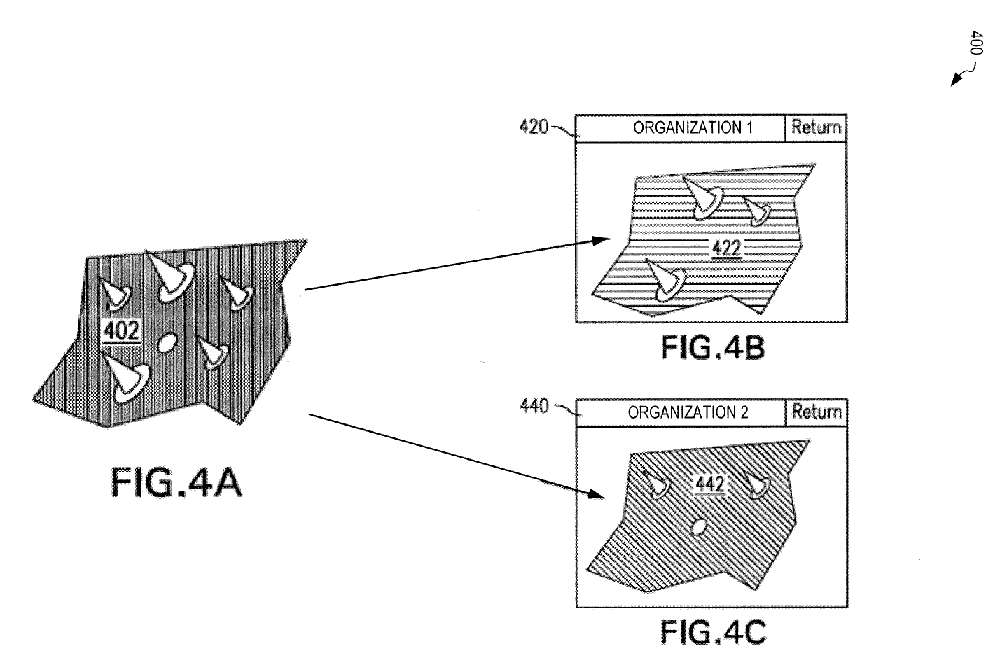

FIG. 4A shows exemplary overlaid organizations 402 that when selected by the user (e.g., by a double left-click on any portion of the overlay that does not contain an object) generates, within server 101, two or more popup organization windows 420 and 440, shown in FIGS. 4B and 4C, that each display one of the overlaid organizations 422 and 442, respectively, represented by overlaid organizations 402.

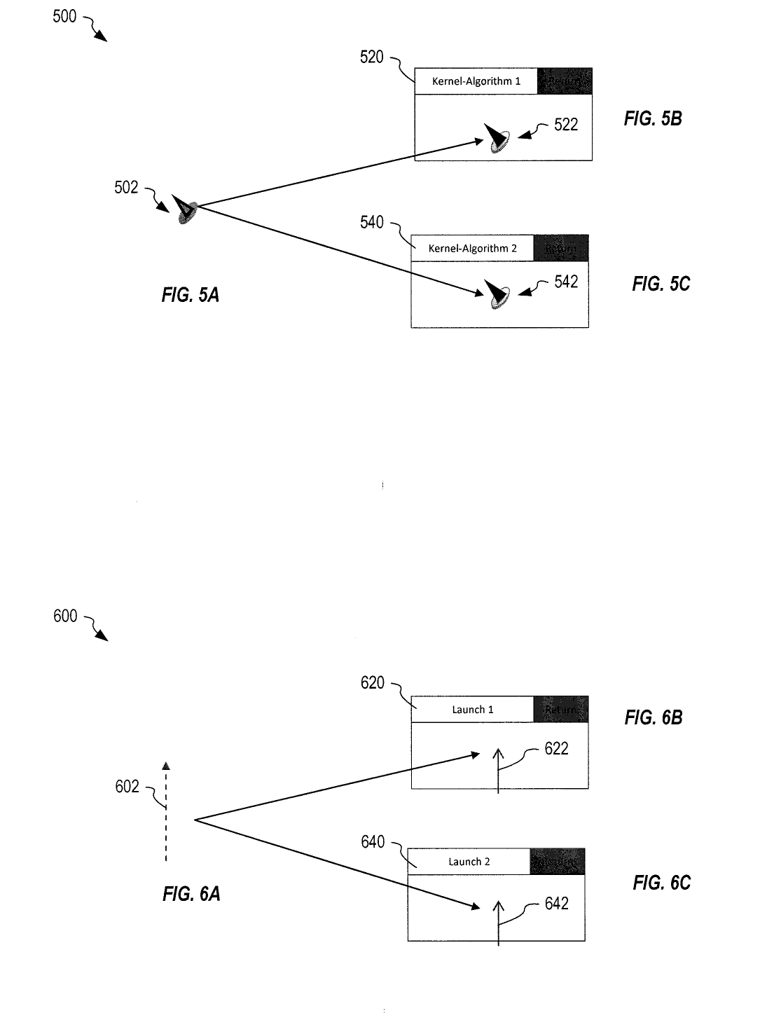

FIG. 5A shows overlaid Kernel-Algorithm 502 that when selected by the user (e.g., by double-clicking the Kernel-Algorithm symbol) generates, within server 101, at least one popup window for each overlaid Kernel-Algorithm represented by overlaid Kernel-Algorithm 502. For example, where overlaid Kernel-Algorithm 502 represents Kernel-Algorithms 522 and 542, server 101 generates pop-up window 520, FIG. 5B, with Kernel-Algorithm 522 and generates popup window 540, FIG. 5C, with Kernel-Algorithm 542.

FIG. 6A shows an exemplary overlaid Kernel-Algorithm launch 602. When the user selects (e.g., by double-clicking the displayed icon), server 101 generates at least one popup display for each overlaid Kernel-Algorithm launch represented by Kernel-Algorithm launch 602. For example, where overlaid Kernel-Algorithm launch 602 represents Kernel-Algorithm launches 622 and 642, server 101 generates pop-up window 620, FIG. 6B, with Kernel-Algorithm launch 622 and generates popup window 640, FIG. 6C, with Kernel-Algorithm launch 642.

### Kernel-Algorithm Categories

There are three ways to create a new Kernel-Algorithm category: a new Kernel-Algorithm-launch keyword list, an updated-Kernel-Algorithm keyword list, and an end-user Kernel-Algorithm-search keyword list. Regardless of where the category is created, it is displayed in the same manner—the algorithm 108 generates a landscape (e.g. landscapes 202, 302) using isometric projection to define the economics of the categories selected for display.

When an organization launches a new Kernel-Algorithm, it attaches a keyword list (e.g., defined within keyword table 112 of database 102, FIG. 1) to that Kernel-Algorithm, as discussed in prior sections. If the attached keyword list contains words that do not occur in any defined category, then the server cluster 107 creates a new category. The boundary of the new category is formed by the percentage overlap between the new category and any other existing category.

When an organization updates an existing Kernel-Algorithm's keyword list and that updated list contains words that do not occur in the Kernel-Algorithm's category, server 101 and/or server cluster 107 expands the category's keyword list to include the new keywords. This expansion affects the boundary of the category with any adjacent category. The boundary is formed by the percentage overlap between the category and any other existing category.

When an end user searches for an Kernel-Algorithm using a keyword list that contains words that do not occur in any category, the server cluster 107 creates a new category. The boundary of the new category is formed by the percentage overlap between the new category and any other existing category.

Upon the creation of a new category, the server 101 displays the Category Naming popup display. The name of the new category needs to be unique. Server 101 ensures that the new category name is unique.

### Merging and Depopulating Categories

Since every category is comprised of Kernel-Algorithms, each with its own list of keywords, adding or deleting keywords to an existing Kernel-Algorithm causes server 101 to compare the Kernel-Algorithm's updated keyword list to the keyword list of the category and adjacent categories. If the new keywords already exist within the category, there is no change. If a keyword of an existing updated Kernel-Algorithm is new to the category, the category expands to include the new keyword. If a new keyword exists in the current category and an adjacent one, the associated Kernel-Algorithm moves to the boundary between the two categories. Kernel-Algorithms found in those adjacent categories may be moved to the newly expanded category. If all keywords of one category are found in another category then the smaller category is merged with the larger category, retaining the name of the larger category. If all Kernel-Algorithms are absorbed by other categories yet there is at least one keyword which differentiates that category from all other adjacent categories, then that category is said to be depopulated but continues to exist.

### Tracking Displayed Objects

There are several objects that can be tracked on a tracking display: Categories, Organizations, and Kernel-Algorithms. On the left side of the Category/Kernel-Algorithm display (e.g., display 200, FIG. 2) is a list of ranked categories with an associated scroll-bar. Using the scroll-bar to move up and down the list of ranked categories shows all available categories. Left-clicking on a category area 204 on the Category/Kernel-Algorithm display 200 causes the selected category to be shown in the list of available categories. Double left-clicking on the category shown on the Category list causes the selected category to be highlighted and all information concerning the category to be displayed. The highlighted category information is comprised of the category name, description, keyword list, and total economic value.

Tracking the current category is accomplished by the selection of the Track button on the Category Information popup screen, which changes the Track button to the Untrack button. Untracking a category is accomplished by selection of the Untrack button.

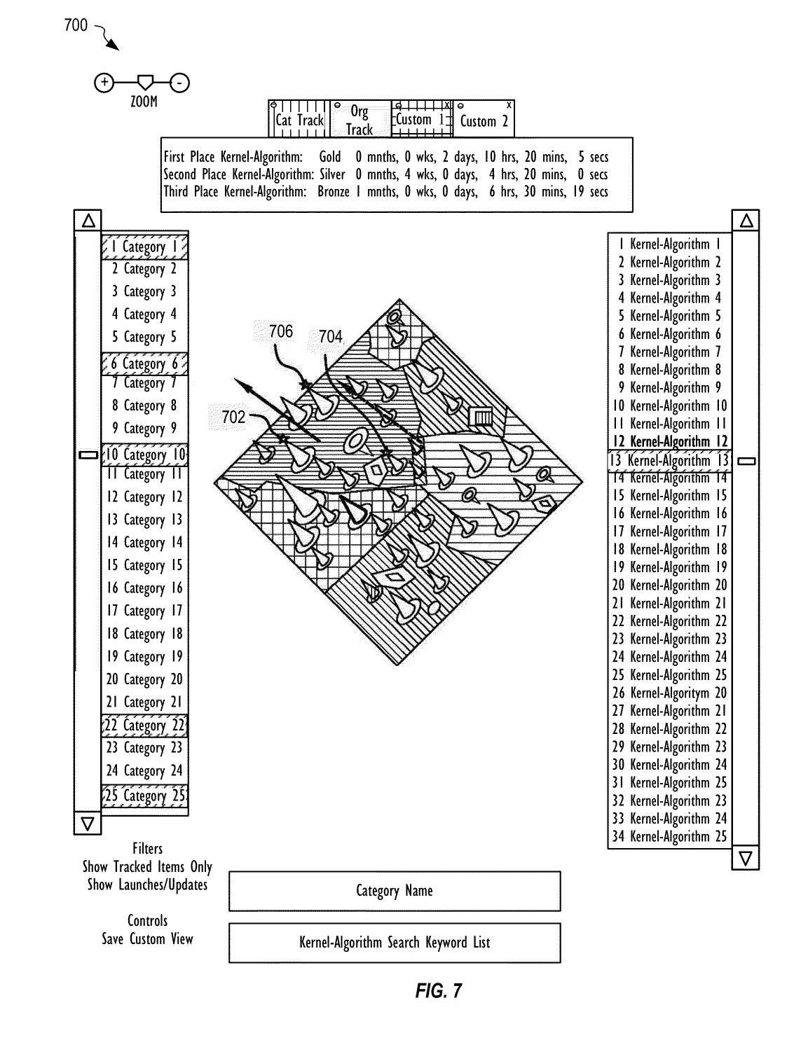

FIG. 7 shows one exemplary Category/Kernel-Algorithm Tracking view 700 showing the top three winning bids 702, 704, and 706, indicated over the Kernel-Algorithm designation. If a user hovers the mouse pointer over a blank area of a landscape comprised of categories, the total economic value of that category is shown. If the user hovers the mouse pointer over a blank area of a landscape comprised of organizations, the total economic value of that organization is shown.

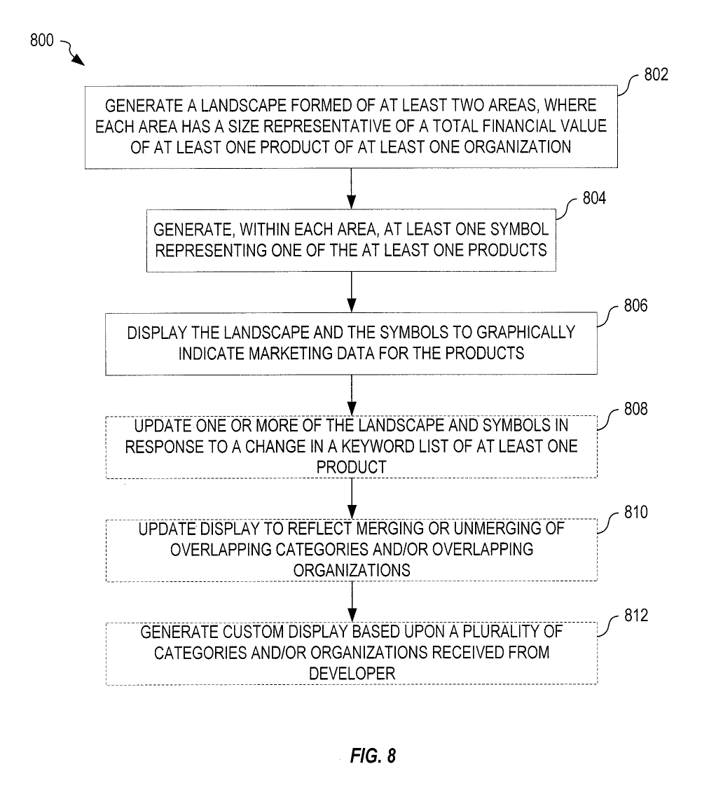

FIG. 8 is a flowchart illustrating one exemplary method 800 for graphically displaying marketing data for a plurality of marketed products, where each product is developed by one of a plurality of organizations using a development environment. Method 800 is for example implemented within management server 101 of FIG. 1.

In step 802, method 800 generates a landscape formed of at least two areas, where each area has a size representative of a total financial value of at least one product of at least one organization. In one example of step 802, market analyzer algorithm 108 utilizes principles of isometric projection, described above, to generate graphical landscape 202 with areas 204(1) through 204(6) based upon a condensed information conveyance model. Landscape 202 may be defined by a total keyword list defining all keywords associated with each of the at least one product (i.e. each product may have one or more of a new Kernel-Algorithm-launch keyword list, an updated-Kernel-Algorithm keyword list, or an end-user Kernel-Algorithm-search keyword list as described above).

In step 804, method 800 generates, within each area from step 802, at least one symbol representing one of the at least one products. For example, market analyzer algorithm 108 utilizes principles of isometric projection to generate one or more symbols, e.g. in the format of cones 206 and disks 208, each respectively representing the at least one products.

In step 806, method 800 displays the landscape from step 802 and the symbols from step 804 to graphically indicate marketing data for the products. For example, market analyzer algorithm 108 may generate graphical marketing display 130 to be displayed on display 122 of developer computer 120. Marketing display 130 may be in category view 200 or organization view 300 without departing from the scope hereof.

In optional step 808, method 800 updates the display from step 806 to reflect a change in one or more of the landscape and symbols in response to a change in a keyword list of at least one of the products. For example, market analyzer algorithm 108 may updated graphical marketing display 130 to reflect an addition and/or deletion of a keyword from keyword table 112.

In optional step 810, method 800 updates display to unmerge and/or merge one of overlapping categories and overlapping organizations. For example, marketing analyzer algorithm 108 may produce windows 420 and 440 to unmerge overlapping organizations 422 and 442. In another example, marketing analyzer algorithm 108 may produce windows 520 and 540 to unmerge overlapping products (i.e. kernel-algorithms 522 and 524).

In optional step 812, method 800 generates a custom display based upon a plurality of categories and/or organizations received from developer. For example, a developer may request specific categories and/or organizations to display within graphical marketing display 130, upon receipt, market analyzer algorithm may generate a custom view displaying all of the received categories and/or organizations.

Combination of Features

Features described above as well as those claimed below may be combined in various ways without departing from the scope hereof. The following examples illustrate some possible combinations:

(A) A method for graphically displaying marketing data for a plurality of marketed products, where each product is developed by one of a plurality of organizations using a development environment, the method including generating, via a processor and within memory coupled to the development environment, a landscape formed of at least two areas.

(B) The method denoted as (A), wherein each area has a size representative of a total financial value of at least one product of an organization and/or a category of products.

(C) The method denoted as either (A) or (B), further including generating, via the processor and within each of the areas, at least one symbol representative of the at least one product.

(D) The methods denoted as (C), further including displaying the landscape and the at least one symbol from the development environment.

(E) In the methods denoted as (A) through (D), the at least one symbol comprising a disk formed within the area and having a size representative of a financial value of the product.

(F) In the methods denoted as (A) through (E), the symbol including a cone representative of a change in sales of the product for a current period as compared to sales of the product for a previous period.

(G) In the method denoted as (E), the cone indicating one of positive and negative change.

(H) In the methods denoted as (A) through (G), the proximity of the symbols to one another representing a commonality between features of said products.

(I) In the methods denoted as (A) through (H), further including displaying new product launches as an additional symbol on the landscape.

(J) In the method denoted as (I), the additional symbol being an arrow.

(K) In the methods denoted as (A) through (J), further including displaying search misses as highlighted areas of the landscape.

(L) In the methods denoted as (A) through (K), further including creating a custom landscape to track various categories of applications.

(M) In the methods denoted as (A) through (K), further including creating a custom landscape to track various organizations.

(N) In the methods denoted as (A) through (K), further including creating a custom landscape to track various kernels and/or algorithms.

(O) In the methods denoted as (L) through (N), the custom landscape being defined by input parameters defined by a user of the development environment.

(P) In the methods denoted as (A) through (O), further including de-convolving at least one of overlapped categories and overlapped organizations.

(Q) In the methods denoted as (A) through (P), further including displaying tope performing kernel/algorithms.

(R) In the methods denoted as (A) through (Q), further including updating the landscape based upon a change in a keyword list of at least one of the at least one product, the organization, and the category of products.

(S) A system for graphically displaying marketing data for a plurality of marketed products, where each product is developed by one of a plurality of organizations using a development environment, the system including memory storing a market analyzer executable by a processor for generating a landscaped formed of at least two areas.

(T) The system denoted as (S), each area having a size representative of a total financial value of at least one product of an organization and/or category of products.

(U) The system denoted as (S) or (T), the market analyzer further for generating within each of the at least two areas, at least one symbol of the at least one product.

(V) The system denoted as (U), the market analyzer further for displaying the landscape and at least one symbol from the development environment.

(W) The systems denoted as (S) through (V), the memory further storing a keyword table defining a list of keywords associated with at least one of the organization, the category, and the product.

(X) The system denoted as (W), the market analyzer further for updating one or more of the landscape and at least one symbol based upon a change in the keyword table.

(Y) The systems denoted as (S) through (X), the symbol including at least one of a disk formed within at least one of the areas and having a size representative of a financial value of one of the at least one products, and a cone representative of a change in sales, of one of the at least one products, for a current period as compared to prior sales of the at least one products.

(Z) The system denoted as (Y), the cone indicating one of a positive and negative change in sales.

(AA) The systems denoted as (S) through (Z), wherein a proximity of one symbol to another symbol representing a commonality between features of the products.

(BB) The systems denoted as (S) through (AA), the market analyzer further including new products as a different symbol on the landscape.

(CC) The system as denoted as (BB), the different symbol being an arrow.

(DD) The systems denoted as (S) through (CC), the market analyzer further for generating a market opportunity on the landscape defining an additional area that is not represented by any of the products.

(EE) The systems denoted as (S) through (DD), the market analyzer further for de-convolving overlapping categories and/or overlapping organizations

(FF) The systems denoted as (S) through (EE), wherein the at least one symbol includes a top performing kernel/algorithm.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for graphically displaying marketing data for a plurality of marketed products, where each product is developed by one of a plurality of organizations using a development environment, comprising:
generating, via a processor and within memory coupled to the development environment, a landscape formed of at least two areas, wherein each area has a size representative of a total financial value of at least one product of an organization and/or a category of products; and
generating, via the processor and within each of said areas, at least one symbol representative of the at least one product; and
displaying said landscape and said symbols from said development environment.

2. The method of claim 1, wherein said symbol comprises a disk formed within said area and having a size representative of a financial value of said product.

3. The method of claim 1, wherein said symbol includes a cone representative of a change in sales of said product for a current period as compared to sales of said product for a previous period, said cone indicating one of a positive and negative change.

4. The method of claim 1, wherein proximity of said symbols to one another represents commonality between features of said products.

5. The method of claim 1, further comprising displaying new product launches as an additional symbol on the landscape.

6. The method of claim 1, further comprising displaying search misses as highlighted areas of the landscape.

7. The method of claim 1, further comprising creating a custom landscape to track various categories of applications and/or various organizations.

8. The method of claim 1, further comprising creating a custom landscape to track various kernels and/or algorithms

9. The method of claim 1, further comprising de-convolving overlapped categories and/or overlapping organizations.

10. The method of claim 1, further comprising displaying top performing kernel/algorithms.

11. The method of claim 1, further comprising updating the landscape based upon a change in a keyword list of at least one of the at least one product, the organization, and the category of products.

12. A system for graphically displaying marketing data for a plurality of marketed products, where each product is developed by one of a plurality of organizations using a development environment, comprising:
memory, the memory storing a market analyzer executable by a processor for
generating a landscape formed of at least two areas, each area having a size representative of a total financial value of at least one product of an organization and/or a category of products;
generating, within each of the at least two areas, at least one symbol representative of the at least one product; and,
displaying the landscape and at least one symbol from the development environment.

13. The system of claim 12, further comprising a keyword table defining a list of keywords associated with at least one of the organization, the category, and the product.

14. The system of claim 13, the market analyzer further for updating one or more of the landscape and at least one symbol based upon a change in the keyword table.

15. The system of claim 12, the symbol including at least one of
a disk formed within at least one of the areas and having a size representative of a financial value of one of the at least one products, and
a cone representative of a change in sales, of one of the at least one products, for a current period as compared to prior sales of the one of the at least one products, the cone indicating one of a positive and negative change in sales.

16. The system of claim 15, a proximity of the disk to another disk representing a commonality between features of said products.

17. The system of claim 12, further including new product launches as a different symbol on the landscape.

18. The system of claim 12, further including a market opportunity defining an additional area within the landscape that is not represented by any of the products.

19. The system of claim 12, the market analyzer further for de-convolving overlapping categories and/or overlapping organizations.

20. The system of claim 12, the at least one symbol including a top performing kernel/algorithm.
